(19) United States
(12) Patent Application Publication
(10) Pub. No.: US 2013/0107125 A1
(43) Pub. Date: May 2, 2013

(54) INDOOR GAP FILLER FOR DIGITAL TERRESTRIAL TELEVISION

(71) Applicant: SECO S.R.L., AREZZO (IT)

(72) Inventors: Daniele CONTI, AREZZO (IT); Marco MAGNAROSA, PISA (IT); Guido NENNA, SAN VITO CHIETINO (Chieti) (IT); Alfredo SALVATORE, SPINETE (Campobasso) (IT); Riccardo MASSINI, SARZANA (La Spezia) (IT); Nicola GALLI, SAN GIULIANO TERME (Pisa) (IT)

(73) Assignee: SECO S.R..L., AREZZO (IT)

(21) Appl. No.: 13/664,965

(22) Filed: Oct. 31, 2012

(30) Foreign Application Priority Data
Nov. 2, 2011 (IT) FI2011A000240

(51) Int. Cl. H04N 5/38

(52) U.S. Cl. 348/723; 348/E05.093

(57) ABSTRACT

A gap filler to retransmit a television signal in indoor environments is described. The gap filler includes: a filtering section; input and output detectors; a power amplifier section; a microprocessor receiving parameters detected by the detectors and controls the amplifier section on the basis of such parameters; and an antenna.

### CROSS REFERENCE TO RELATED APPLICATIONS

The present application claims priority to Italian patent application FI2011A000240 filed on Nov. 2, 2011 and incorporated herein by reference in its entirety.

### FIELD

The present application describes a device for retransmission of a television signal, or gap filler. In particular, it describes a gap filler for indoor digital terrestrial television.

### BACKGROUND

In recent years, analog television is gradually being abandoned in favor of digital technologies, which guarantee a better quality picture and sound, allow interactivity via a return channel, thus expanding the range of services, are able to transmit more channels in the same bandwidth, and require less transmission power to cover the same geographical area.

The standards for digital terrestrial video broadcasting in the world are many and diverse. In different continents and in different states of the same continent, the standards applied may differ, resulting in incompatibilities between systems receiving and transmitting the signal. For example, the United States and North America generally use the ATSC system, based on 8VSB modulation, Europe and parts of Southeast Asia use DVB-T and DVB-H, based on OFDM modulation, while Japan and South America use ISDB-T based on QAM-OFDM.

DVB-T is world's most popular digital terrestrial broadcasting standard. It is developed by the DVB consortium and distributed in over 30 countries. It uses VHF/UHF and allows transmission from 4 to 7 digital channels in places where now not even a single analog channel can pass.

In particular, the European standard uses the following frequencies:
Band III—VHF 174-240 MHz
Band IV—UHF 470 to 606 MHz
Band V—UHF 606 to 870 MHz

The reference standards for DVB-T are:
ETSI EN 300 744 v1.6.1 (2009-01)—Digital Video Broadcasting (DVB), Framing structure, channel coding and modulation for digital terrestrial television.
ETSI TR 101 190 v1.3.1 (2008-10)—Digital Video Broadcasting (DVB); Implementation guidelines for DVB terrestrial services; Transmission aspects.
ETSI EN 302 755 v1.1.1 (2009-09)—Digital Video Broadcasting (DVB); Frame structure channel coding and modulation for digital terrestrial broadcasting in second generation system (DVB-T2).

Throughout Europe, “switching-off” of the analog signal in favor of the digital terrestrial television is currently being carried out. In Italy, for example, this operation should be completed in all regions by the end of 2012. The introduction of digital terrestrial television concerns not only conventional television equipment but is being introduced in all areas of production of new advanced machines that provide new end-user interactive television services.

One of the advantages of digital transmission compared to analog transmission is the reduced need for transmission power for covering large geographical areas. The main disadvantage is that the digital modulation signal is more sensitive to the problems of “gray areas” and destructive interference phenomena due to the presence of obstacles, such as buildings, walls, mountains.

A gap filler is a device to retransmit a television signal. In particular, a gap filler is, for example, a broadcast signal repeater device (not point-to-point) for the coverage of shadow zones, thus suitable to pick up a signal from an external source and retransmit it in a more or less extended geographical area, not covered by the signal, to one or more independent receivers simultaneously. To such purpose, normally broadcast DVB transmission systems already provide for the use of gap fillers, but these are usually of medium to high power, suitable to cover areas such as cities or mountain valleys in the shade, and are complex instruments dedicated to experts in the field. However, even with the availability of such means, often, especially inside buildings, the signal strength is not sufficient for direct reception of digital TV; connection of the receiver to the antenna of the building is needed in order to have a sufficient quality of the received images. This situation de facto prevents mobility of the receiver in environments such as houses, gyms and business centers.

Current retransmission systems may be regenerative or non-regenerative systems. Regenerative gap fillers provide for demodulation of the baseband signal, decoding and encoding of the signal, before final remodulation. Such gap fillers are able to remodulate the original signal even on different channels. Non-regenerative gap fillers provide instead demodulation at baseband or intermediate frequencies, a simple filter and a retransmission on the same or different channel. Both types of gap fillers have a high technical complexity of realization and normally are able to repeat a limited number of channels. In addition, the power retransmitted is high, not suitable for indoor environments.

Currently, the techniques used to allow good wireless direct reception quality inside buildings include:
Increase of power transmitted by the broadcaster, which is uneconomical and in any case not decisive,
Use of indoor gap fillers. The latter present the problem of not being designed for this particular application, have elevated power and complexity, with consequent installation costs and use out of the market.

### SUMMARY

The solution proposed by the present disclosure overcomes the limitations of current technologies in the context of indoor use, for the coverage of relatively small, enclosed areas.

According to some embodiments of the present disclosure, a non-regenerative adjustable gain gap filler in the UHF band is described, for simultaneous indoor retransmission of all digital terrestrial TV channels. The gap filler or indoor analog repeater picks up the television signal from an antenna external to the indoor environment, filters, amplifies and then retransmits the signal in the air inside the indoor environment.

The gap filler according to the present disclosure, by eliminating the frequency conversion and decoding stages, also reduces implementation costs. In addition, it allows installation flexibility through configuration with an integrated internal or external antenna, configurable to cover different types of environment.

The technical advances, compared to the problems detected in the existing systems, are determined by the following characteristics and techniques of some embodiments of the present disclosure:
Use in private/public use indoor environments at the same time on several independent receivers;
Multistandard, can work with all DTT standards (DVB-T, DVB-T2, ATCS, etc.);
Compact size transmission antenna integrated in the gap-filler device, thus allowing easy installation even by unskilled persons;
Algorithm for controlling the power retransmitted as a function of the environment and of the received signal, prevents auto-resonance of the system;
Elimination of conversion stages of the signal, allowing a processing entirely in radiofrequency (RF);
Lower cost;
Limitation of in-out signal delay, which can cause interference.

According to an aspect of the present disclosure, a device to retransmit a television signal is provided, comprising: a filtering section to filter the television signal received by the device; an input detector, adapted to detect the television signal filtered by the filtering section; a power amplifier section of the television signal filtered by the filtering section; an output detector, adapted to detect the television signal amplified from the power amplifier section; a microprocessor connected to i) the input detector to receive input parameters detected by the input detector, ii) the output detector to receive output parameters detected by the output detector and iii) the power amplifier section to control the power amplifier section on the basis of the input parameters detected by the input detector and the output parameters detected by the output detector, and an antenna adapted to retransmit the television signal amplified by the power amplifier section.

Further aspects of the present application are provided in the present specification, drawings and claims.

Several may be the technical advantages of certain embodiments of the disclosure:

Allowing wireless receipt of the signal in indoor environments otherwise not covered, with reasonable cost and complexity;
Multi-standard adaptability (DVB-T, DVB-H, DAB, ATSC, etc.), independently from the standard adopted;
Frequency adaptability in any Region/State by simple adjustment of the input filter to the desired band;
Estimated processing delay far below the threshold interval of the transmission system, thus not forming multipath disturbance, in particular outside the building of use;
Easy installation and automatic use.

### BRIEF DESCRIPTION OF THE DRAWINGS

Reference will be made to the figures attached to the present application, shown by way of example and not of limitation.

FIG. 1 shows a block diagram of an embodiment of the gap filler according to the present disclosure.

FIG. 2 shows an example of application of the gap filler according to the present disclosure.

FIGS. 3(a) and 3(b) show an example of a circulate embodiment of the gap filler according to the present disclosure.

FIG. 4 shows a flow chart of a mode of operation of the microprocessor of the gap filler according to the present disclosure.

FIG. 5 shows examples of application in an indoor environment of the gap filler according to the present disclosure.

FIG. 6 shows an embodiment with a plurality of gap fillers according to the present disclosure.

FIG. 7 shows examples of embodiments of the outer shape of the gap filler.

### DETAILED DESCRIPTION

A gap filler for digital terrestrial television is described, for use in indoor environments. The digital terrestrial television signal is thus made available in wireless mode in indoor environments, in order to allow receivers to use the service in a mobile mode, without the need of a direct connection to the antenna system.

According to some embodiments of the present disclosure, the gap filler is able to operate independently of the transmission standard adopted and is self-regulating, in order to limit interference problems with other radio devices.

The gap filler is self-adjusting, to avoid the need of a direct intervention for unskilled persons, both during installation and periodic adjustment. In particular, a microprocessor is provided for:
Adjusting the re-transmitted power according to the needs dictated by the signal source,
Monitoring and reporting device malfunctions that may generate noise in the television signal,
Avoiding phenomena starting self-oscillation and generating noise due to poor insulation of the input and output ports.

The chosen implementation, to keep costs low and compatibility with all standards, provides for use of analog non-regenerative technology to realize the gap filler. No frequency conversions are provided, to also avoid isofrequency problems of the signal retransmitted from the gap filler.

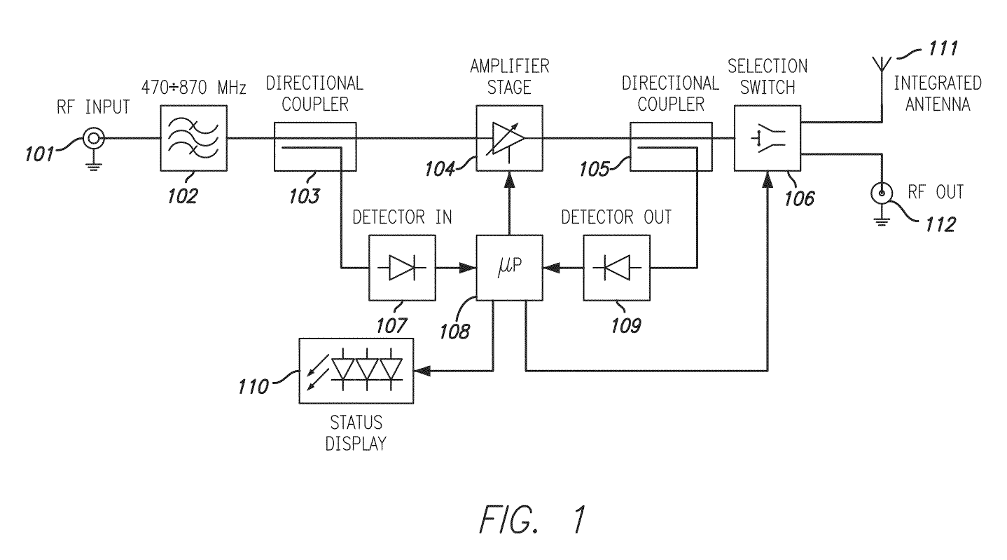

As shown in the embodiment of FIG. 1, the gap filler comprises a filtering section or block (102) formed, for example, by a bank of filters, for selection of channels of interest. The filtering section, in the exemplary case of DVB-T standard, selects the entire UHF band dedicated to digital transmission or can be modified to receive only a part of the desired channels.

The system also comprises a stage, unit, module or section (104) for power amplification of the television signal received from the filtering section (102). In some embodiments, section (104) also allows low noise introduction, to preserve the quality of the audio-video signal, to avoid perceptible degradations for the end user. The amplification gain can be electronically variable, to adapt the device to different environments and installation situations on the market. For example, low noise can be obtained by choice of electronic components, such as amplifier modules (104), board layout, and thermal dissipation (because at a lower temperature corresponds a lower thermal noise). Electronic variability of the gain can be obtained instead, for example, via gain control pins arranged on the amplifier modules (104).

At the input and output to the amplification stage (104), two wideband directional couplers (103, 105) are provided, to take a portion of the signals received and retransmitted by the amplification stage (104), in order to monitor their time behavior by means of two detectors (107, 109). The detectors (107, 109) can detect the power level of the input (101) and output (112) signals, as well as additional parameters of such signals. The detectors (107, 109), made in an identical manner in the embodiment shown in the figure, take as input a signal variable over time and return as output a DC voltage proportional to the amplitude of the input. If the input changes, the voltage output level changes accordingly. The processor (108) can sample such signal at set time intervals (e.g., every 20 ms) to see what is the level and whether there have been variations with respect to the previous interval. In this way, correct operation and any malfunctions can be monitored.

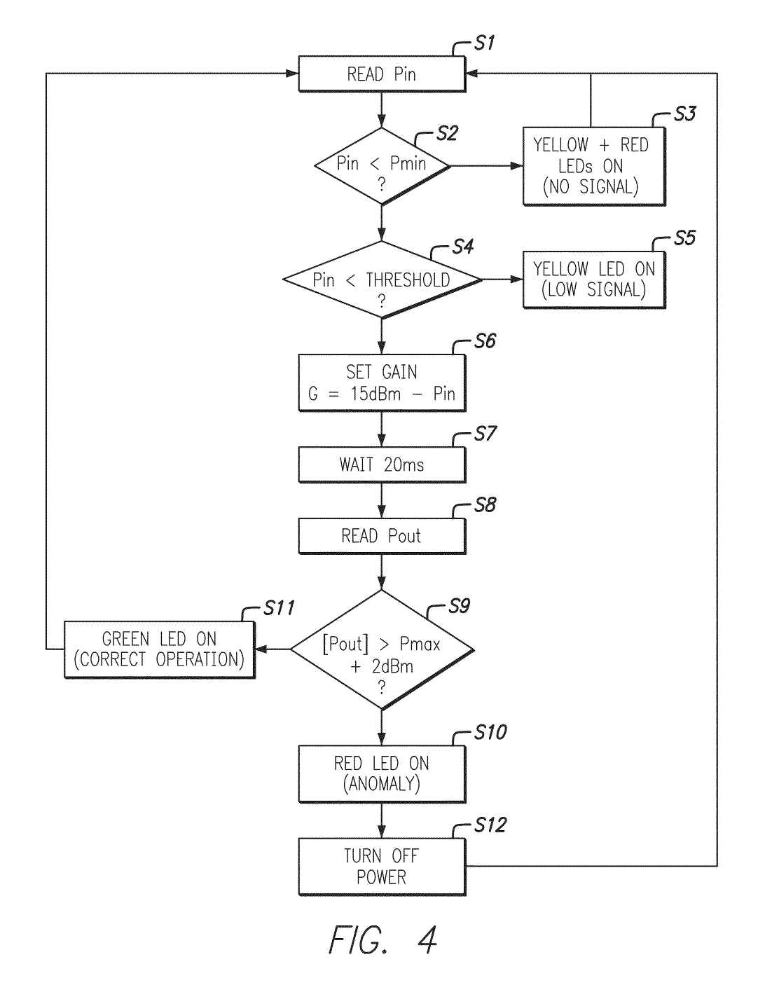

It is also possible to continuously adjust the amplification gain of the stage (104), to compensate for temporary variations of the transmission system, for example due to atmospheric conditions. In particular, the processor (108), based on the input power read via the detector (107), directly sets the gain to get the in-out power of the amplifiers equal to a chosen value (e.g., 15 dBm), by way of the expression Gain=(Amplifier Pout chosen value)−Pin, as also later described in step S6 of FIG. 4.

The system also includes a microprocessor (108), which takes as input the signals detected by the detectors (107, 109) for adjusting the operation of the whole system. The microprocessor (108), through an internal algorithm, varies the gain of the amplification stage (104), turns the system on and off, detects malfunctions and reports them to the user through a LED panel display (110). In particular, the system may signal: a) Level of television signal input to input connector (101) is too low, b) Proper system operation, and output power status, c) System error, system in auto-resonance, need for maintenance.

A further element of the embodiment shown in FIG. 1 is a switch/electronic selector (106) which allows selection of a desired output for retransmission. In the embodiment shown in FIG. 1, selection is made between an integrated antenna (111) and a connector (112) for external antenna. In the case in which an external antenna connector is not present, the switch (106) can be set directly on an output corresponding to the integrated antenna (111).

As shown in FIG. 1, the input and the output of the filtering section (102), the input of the input detector (107), the input and the output of the power amplification section (104), the input to the output detector (109) and the antenna input (111) are radio frequency (RF) signals.

The integrated internal antenna (111) can be optimized for operation in indoor environments. In particular, the antenna can ensure uniform and omnidirectional coverage within an indoor environment. The mechanical integration of the antenna can also ensure ease of installation because it allows the end user to avoid the need of positioning the antenna and allows to ensure isolation from the internal circuitry, to avoid self-resonance.

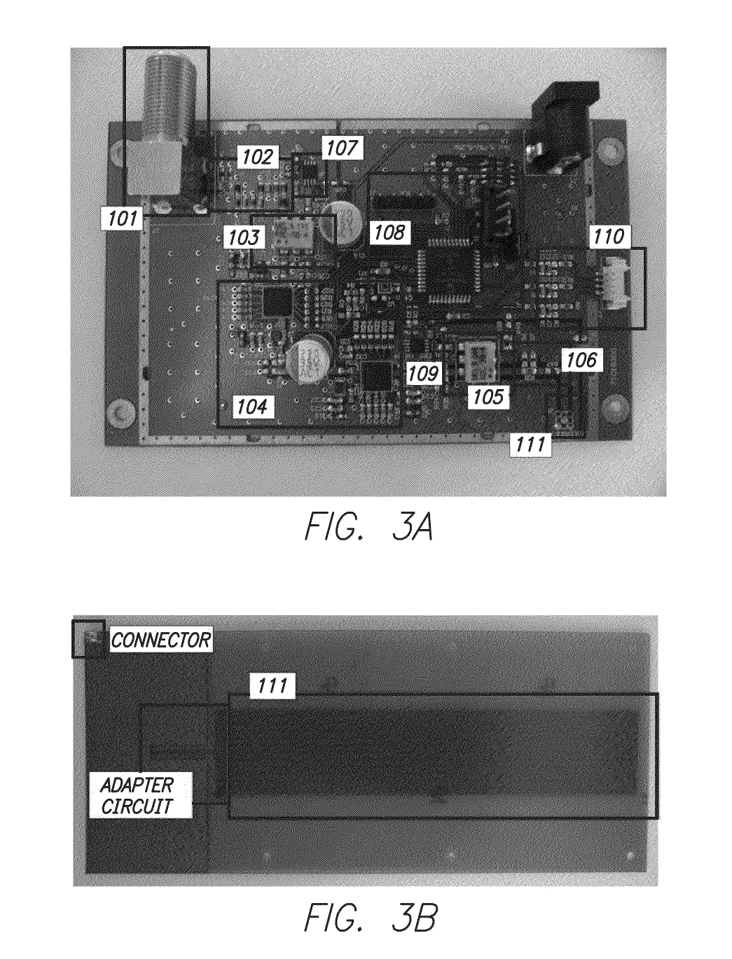

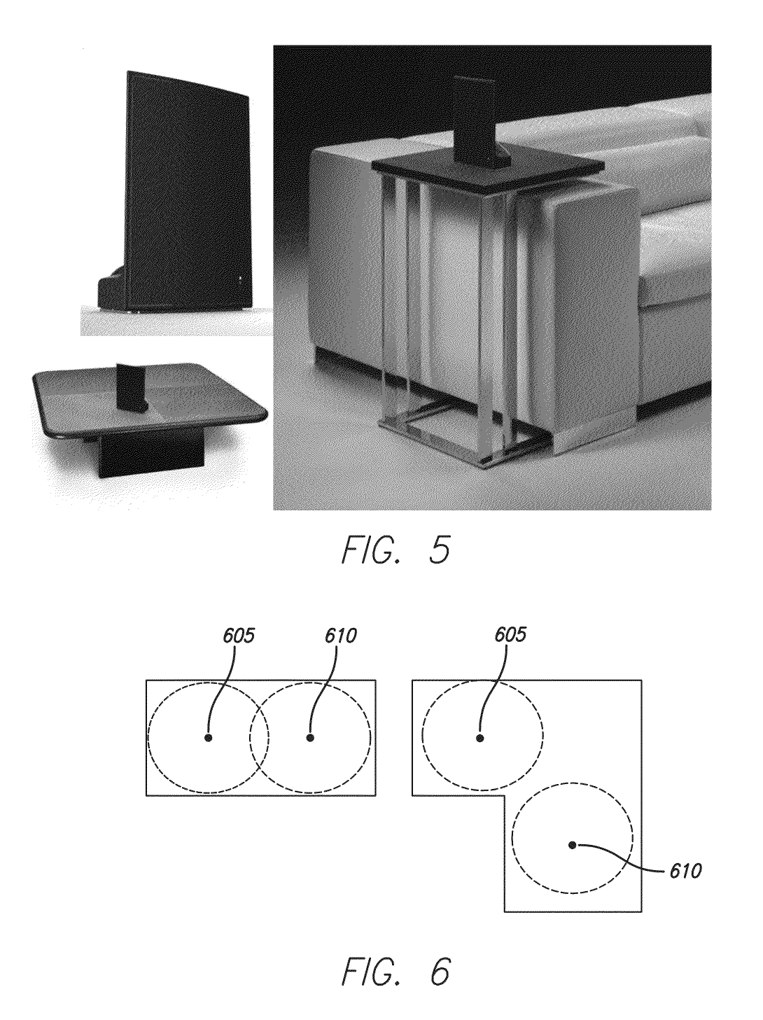

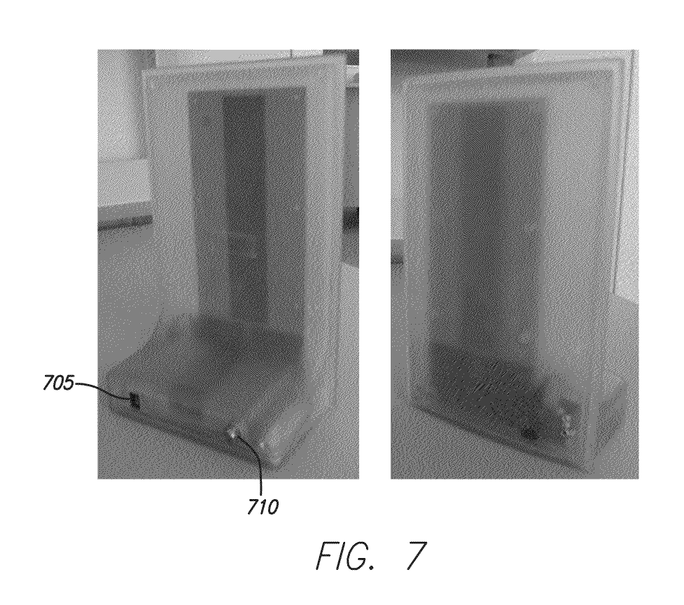

By way of example, the integrated antenna (111) may be a “grating antenna” characterized by multiple and very close resonances, which allow coverage of the entire operating band. As later shown in FIG. 3(b), the antenna can be accompanied by a microstrip matching circuit and a connector for direct connection to the gap filler. The matching circuit has the function of ensuring resonance of the antenna when the antenna is connected to the gap filler, thus eliminating unwanted coupling with the circuit and the metal shield. The antenna can be realized in such a way that reflection due to the plastic cover of the enclosure does not affect operation. The microstrip antenna matching circuit is realized via a shaped septum (305) (FIG. 3(b)) and sized on the ground plane of the antenna itself. In this manner, a proper impedance transition between the electronic circuit of the gap filler and the antenna itself can be obtained, so that there is no mismatching or displacements of the operating frequency of the antenna at the time of integration within the structure. In particular, the septum allows operation of the antenna within the support structure of the gap filler, in the position assigned to the antenna at a certain distance from the electronic circuit and from the metal protection and dissipation parts, acting both as a mechanical and electronic design of the antenna. See also FIGS. 5 and 7.

Optionally, a connector for external antenna may be provided (see element 112 in FIG. 1) for use with antennas that are more directional in order to cover particular spaces.

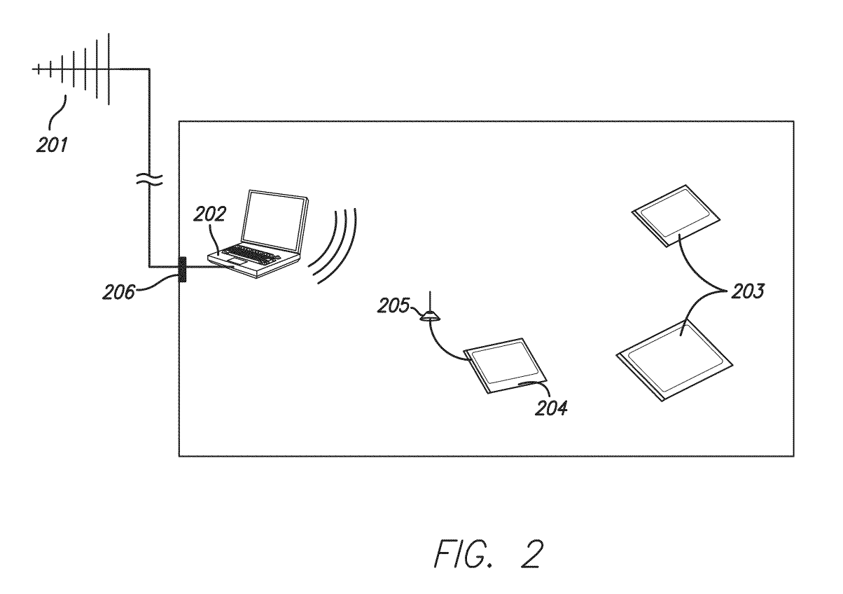

FIG. 2 is a schematic diagram showing an example of application of the gap filler according to the present disclosure. The gap filler (202) according to the present disclosure is disposed inside of an indoor environment and connected with an external antenna (201) via an antenna connector (206). The antenna of the gap filler (202) retransmits the television signal, which can be received by devices within the indoor environment and distant from the gap filler (202), such as mobile receivers (203) with integrated antenna and/or mobile receivers (204) with an external antenna (205).

A possible field of application of the device according to the present disclosure is inside gyms, to allow reception of a digital television signal on exercise machines (equipped with receivers such as the receivers (203) and (204) of FIG. 2) in a wireless mode. The need arises from the fact that the position of the machines within the premises can vary in function of the situation and moment. A prior art receiver with a direct connection to the antenna system requires from time to time availability of a connection point for each machine, together with the possibility of laying cables inside the gym, a pretty complex situation. Through use of the device according to the present disclosure, each gym machine can include not only an integrated receiver but also a receiving antenna integrated in the receiver. In this way, it is possible to position the machines irrespective of the availability of an antenna connection.

Other application scenarios can be provided by shopping centers, or private homes. It is no longer necessary to locate an antenna connection in the vicinity of places where the receivers are located, as a receiving antenna for receiving the digital television service will be enough.

A first possible advantage of the device according to the present disclosure is the speed and ease of installation. Wiring an environment for accessing the service is no longer needed. The gap filler can simply be placed at a suitable point of an indoor environment, connected to the power supply and the plant of antenna, and it will automatically retransmit the signal throughout the environment. The receiver thus does not need a connection point, so that it can be freely positioned and moved according to the needs. As a consequence, mobile reception in indoor environments becomes possible.

A second possible advantage is the ease of reconfiguration: from time to time and in accordance with the need, the receivers and the gap fillers can be immediately repositioned. If the scenario of use changes, for example in case of introduction of new receivers or modifications in the environment of use, so that reception by some receivers may be compromised, it is sufficient that the end user physically reposition the gap filler or install an additional one to ensure continuity of operation.

In particular, if the environment is larger than coverable by a single gap filler, two or more gap fillers (605, 610) can be installed, as shown in FIG. 6. These gap fillers are independent of each other, in the sense that each picks up the signal from the building and re-transmits it in its coverage area. The left panel of FIG. 6 shows a case where there is an intersection between the spaces covered by the two gap fillers (605, 610), while the right panel of FIG. 6 shows a case where there is no intersection.

A further advantage is given by the fact that each receiver is independent of the others and has all the available channels in the air. Each digital television service user can pick and choose one of the available channels, independently from other users. The available channels are not limited, as in the case of the prior art.

FIG. 3(a) shows a perspective top view of an embodiment of the circuit of the device of FIG. 1 (without the optional output (112)), where the same reference numbers shown in FIG. 1 are used.

FIG. 3(b) shows an integrated embodiment of the antenna (111) shown in FIG. 1 and FIG. 3(a).

FIG. 4 schematically shows a possible algorithm of operation of the microprocessor (108) described in FIG. 1, in the case in which input power Pin to the amplifier stage (104) and output power Pout from the amplifier stage (104) are evaluated. In the example shown in the figure, Pin is read in a step S1 and compared with a minimum power value Pmin in a step S2. If Pin<Pmin, both a yellow LED and a red LED of component (110) (see FIG. 1) are turned on in a step S3, indicating absence of signal. Otherwise, in a step S4, if Pin<Pthreshold, just a yellow LED of component (110) is turned on in step S5. Otherwise, in a step S6, a gain for the amplification stage (104) is set (e.g., G=15 dBm−Pin) and, after a waiting time (step S7), output power Pout is read in a step S8. In a decision step S9, it is evaluated whether Pout is greater than a maximum acceptable power, in which case a red LED of the component (110) is turned on in a step S10 and the power is then turned off in a step S12. Otherwise, a green LED of the component (110) is turned on in a step S11.

As noted previously, the system can avoid cases where self-oscillation is started. This can be done by setting an allowed in-out power of the amplifiers to be less than their maximum in-out power (e.g., 15 dBm compared to a maximum power of 20 dBm). If the device puts itself into self-oscillation, control of allowed power is no longer provided. In this way, the effective power of the amplifiers reaches (or comes very close to) the maximum power, thus generating an error. Alternatively, a second self-start control mode can take place by controlling the input out-of-band power. This can occur through the components (103) and (107) (directional couplers and detector) described above.

According to some embodiments, the device of the present disclosure performs an input power control. This can be done by setting the allowed in-out power of the amplifiers to a value even lower than the value of the embodiment of the previous paragraph (e.g., 10-12 dBm compared to a maximum power of 20 dBm). This option can be implemented by software through the microprocessor described above, as noted in steps S4-S6 of FIG. 4.

FIG. 5 shows examples of application of the gap filler according to the present disclosure in an indoor environment. Some embodiments of the outer shape of the gap filler are shown in FIG. 7, which also shows an input (710) corresponding to the input (101) of FIG. 1, and an output (705) corresponding to the output (112) of FIG. 1. In particular, the shape is such that:

i) a certain distance between the antenna and electronics is maintained, so they do not interfere with each other;
ii) ease of installation is allowed (the gap filler can be simply placed on a table or shelf or other flat surface and connected);
iii) If desired, the gap filler can be wall mounted using an articulated arm support (similar to those supporting a TV) to be screwed to the base of the gap filler.

The present invention has been described by means of embodiments shown by way of example and not of limitation. It is to be understood that the scope of protection of the same is to be found in the claims appended hereto.

1. A device to retransmit a television signal, comprising:
a filtering section to filter the television signal received by the device;
an input detector, adapted to detect the television signal filtered by the filtering section;
a power amplifier section of the television signal filtered by the filtering section;
an output detector, adapted to detect the television signal amplified from the power amplifier section;
a microprocessor connected to i) the input detector to receive input parameters detected by the input detector, ii) the output detector to receive output parameters detected by the output detector and iii) the power amplifier section to control the power amplifier section on the basis of the input parameters detected by the input detector and the output parameters detected by the output detector, and
an antenna adapted to retransmit the television signal amplified by the power amplifier section.

2. The device according to claim 1, further comprising:
an input directional coupler adapted to couple the television signal filtered by the filtering section to the input detector, and
an output directional coupler, adapted to couple the television signal amplified by the power amplifier section to the output detector.

3. The device according to claim 1, further comprising:
a selector, controlled by the microprocessor, configured to direct the television signal amplified by the power amplifier section to the antenna or to an optional antenna output.

4. The device according to claim 1, further comprising:
a display unit, controlled by the microprocessor, to display a status of the device.

5. The device according to claim 1, wherein the parameters detected by the input detector and the output detector, respectively include a power level of the television signal filtered by the filtering section and a power level of the television signal amplified by the power amplifier section.

6. The device according to claim 1, wherein the parameters detected by the input detector and the output detector respectively include an input power of the television signal upstream of the power amplifier section and a power output of the television signal downstream of the power amplifier section.

7. The device according to claim 1, wherein the power amplifier section is a variable gain amplifier section, the microprocessor being capable of controlling said variable gain during use of the device.

8. The device according to claim 7, wherein the microprocessor controls the variable gain based on an input power of the television signal, said input power being detected by the input detector.

9. The device according to claim 8, wherein the variable gain is a function of i) the input power of the television signal and ii) power in-power out of the power amplifier section.

10. The device according to claim 9, wherein the power in-power out of the power amplifier section is selectable, prior to use of the device, to a value lower than the maximum power in-power out value for the power amplifier section.

11. The device according to claim 4, wherein the microprocessor indicates operative or non-operative states of the device through the display unit.

12. The device according to claim 11, wherein said states include one or more of: no television signal input, low input television signal, proper operation, malfunction and abnormalities.

13. The device according to claim 1, wherein the filtering section, the input detector, the power amplifier section, the output detector, the microprocessor, and the antenna are placed inside a container.

14. The device according to claim 13, where the antenna is a grating antenna.

15. The device according to claim 13, comprising the selector and further comprising a microstrip matching circuit capable of connecting the antenna to the selector.

16. The device according to claim 15, wherein the filtering section, the input detector, the power amplifier section, the output detector and the microprocessor are arranged along a first level of the container, and the antenna is arranged along a second level of the container.

17. The device according to claim 16, where the second level of the container is substantially orthogonal to the first level of the container, the container exhibiting a substantially L-shaped configuration.

18. The device according to claim 1, wherein the input and the output of the filtering section, the input of the input detector, the input and the output of the power amplifier section, the input of the output detector and the input of the antenna are radiofrequency (RF) signals.

19. A system for retransmitting a television signal in an indoor environment, comprising:
the device according to claim 1, the device being adapted to be connected to an antenna external to the indoor environment and being adapted to retransmit the television signal taken from the antenna; and
one or more wireless receivers, having an external or integrated antenna, adapted to receive the television signal retransmitted by the device.

20. A system for retransmission of a television signal in an indoor environment, comprising:
a plurality of devices according to claim 1, the plurality comprising two or more said devices arranged one downstream of the other in the indoor environment.
